(19) United States
(12) Patent Application Publication
(10) Pub. No.: US 2013/0104180 A1
(43) Pub. Date: Apr. 25, 2013

(54) METHOD AND SYSTEM FOR DELIVERING INTERACTIVE CONTENT

(71) Applicant: Philip Knightbridge, Lambertville, NJ (US)

(72) Inventor: Philip Knightbridge, Lambertville, NJ (US)

(73) Assignee: INTERACTIVE BROADBAND CONSULTING GROUP, LLC, Philadelphia, PA (US)

(21) Appl. No.: 13/278,508

(22) Filed: Oct. 21, 2011

(51) Int. Cl. H04N 21/20

(52) U.S. Cl. 725/116

(57) ABSTRACT

A system for delivering content to a user is disclosed. The system includes information with the content and an interactive application that is accessed by interacting with the information. The information includes at least one instruction for allowing a user to access the interactive application. The interactive application enables further user interaction with the system.

### FIELD OF INVENTION

The present invention is directed to a system and method for delivering interactive content. More specifically, the present invention is directed to embedding information in distributed content for subsequent action by a user receiving the information and distributed content.

### BACKGROUND

Broadcast information has been around for decades in the form of radio and television programming along with associated advertising. Although advertisers try to tailor their advertising to the tastes of the viewers of the programming, viewers can only see the advertising in real-time. This leaves viewers often wanting more information than is included within the advertisement. And while advertisements are used as an example, users desire access to more information and other content.

In this regard, the Internet has been successful as a result of providing access to a huge amount of information. This ubiquitous information and the connectivity it provides has pervaded society. However, this information is generally unorganized and often delivered only upon specific request. As a result, users have to wade through endless numbers of web pages in order to find the desired information.

Thus, there exists a need for a system and method that unites broadcast information and easy access to underlying content and directed information.

### SUMMARY

A system for selectively delivering content to a user is disclosed. The system includes information with the content and an interactive application that is accessed by interacting with the information. The information includes at least one instruction for allowing a user to access the interactive application. The interactive application enables further user interaction with the system.

A method for providing interactive content is disclosed. The method includes delivering content including information, processing at least the inband information, and launching an application based on the processed inband information. The launched application provides interactive content to a user.

### BRIEF DESCRIPTION OF THE DRAWING(S)

Understanding of the present invention will be facilitated by consideration of the following detailed description of the preferred embodiments of the present invention taken in conjunction with the accompanying drawings, in which like numerals refer to like parts:

FIG. 1 illustrates a system for delivering interactive content;

FIG. 2 illustrates exemplary content within the system of FIG. 1;

FIG. 3a illustrates an exemplary distribution network for delivering content;

FIG. 3b illustrates an exemplary distribution network for delivering content;

FIG. 4 illustrates a receiving device within the receiving network of the system of FIG. 1;

FIG. 5 illustrates a delivery architecture based on to be delivered content including an inband information that is embedded in the content during production;

FIG. 6 illustrates a delivery architecture based on to be delivered content not including an inband information that is embedded in the content during production;

FIG. 7 illustrates an interaction network of the system of FIG. 1;

FIG. 8 illustrates a method for content delivery;

FIG. 9a illustrates an exemplary receiving device and application initiation architecture;

FIG. 9b illustrates an exemplary receiving device and application initiation architecture;

FIG. 9c illustrates an exemplary receiving device and application initiation architecture; and

FIG. 10 illustrates a configuration of system running an application that relates to and uses enhanced content.

### DETAILED DESCRIPTION OF THE PREFERRED EMBODIMENT(S)

It is to be understood that the figures and descriptions of the present invention have been simplified to illustrate elements that are relevant for a clear understanding of the present invention, while eliminating, for the purpose of clarity, many other elements found in systems and methods for delivering content. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

The present invention provides a system and method for selectively providing content to a user. The system and method includes information with the content and an interactive application that is accessed by interacting with the information. The information includes at least one instruction for allowing a user to access the interactive application. The interactive application enables further user interaction with the system. The system and method also includes delivering content including inband information, processing at least the inband information, and launching an application based on the processed inband information. The launched application provides interactive content to a user.

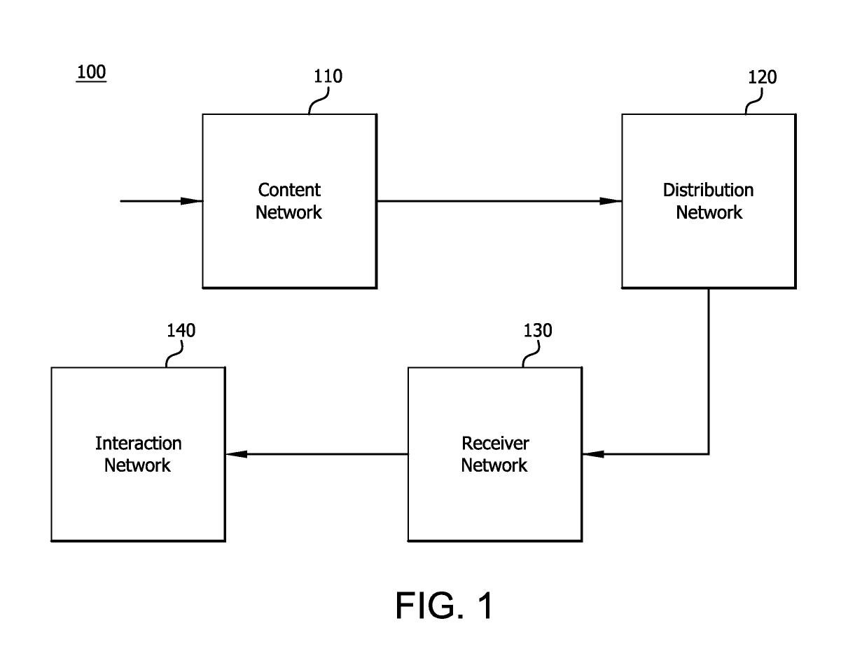

FIG. 1 illustrates a system 100 for delivering interactive content. System 100 may include a content network 110, a distribution network 120 for delivering the content of content network 110, a receiver network 130 for receiving the delivered content, and an interaction network 140 for providing the received content to a destination, such as a user. System 100 may operate where content is delivered to a consumer. System may include broadcast systems, such as radio or television, Internet content delivery, and the like.

Content network 110 may operate to provide content for delivery to a user. This content may include information that may be accessed or acted upon by receiver network 130. Receiver network 130 may act on or access inband signals that carry inband information. Receiver network 130 may gather the information included within the inband information and carry out a subsequent action as directed by the information gathered from the inband information. The subsequent action may include activating interaction network 140. Interaction network 140 may be local to receiver network 130 or may be accessed by receiver network 130 via a wireless or wired network connection, for example. This connection may be the same connection that provided the content and the inband information, or may be across a different connection. The connection may be the same type of connection that provided the content, such as both wireless communications, or may be unrelated to the previous connection type. Interaction network 140 may host an application for continuing customer/user interaction.

More specifically, content network 110 may include a source of the content, such as a content creator or provider. Content network 110 may include accumulation and distribution of television shows, news, sports, movies, and other forms of content. Content within content network 110 may be created by a content provider. Content may take the form of a television show, or program, a radio spot, or web-based content, for example. Content may be any content that is dispersed, such as by broadcasting, networking, or publishing, for example. Content may include content delivered by broadcast systems, such as radio or television, Internet content delivery, and the like. This content may include delivered media, such as television programs, media displayed from a DVR or PDR or media accessed via on-demand delivery, for example.

By way of non-limiting example only, radio programming may be the content and may be broadcast by radio stations or the Internet. Similarly, television programming may be the content and may be broadcast by television (both broadcast and cable, for example) stations or the Internet. Web content may be the textual, visual or aural content and may be encountered as part of the user experience on websites. Content may include, among other things: text, images, sounds, videos and/or animations.

As used herein, broadcasting may be the distribution of audio and video content to a dispersed audience via radio, television, or other medium. Receiving parties may include the general public or a relatively large subset thereof. Similarly, publishing may be the process of production and dissemination of literature or information—the activity of making information available to the general public or a subset thereof. In some cases, authors may be their own publishers, meaning: originators and developers of content may provide content to deliver and display the content. Broadcasting and publishing may be used interchangeably herein in referring to either or both concepts.

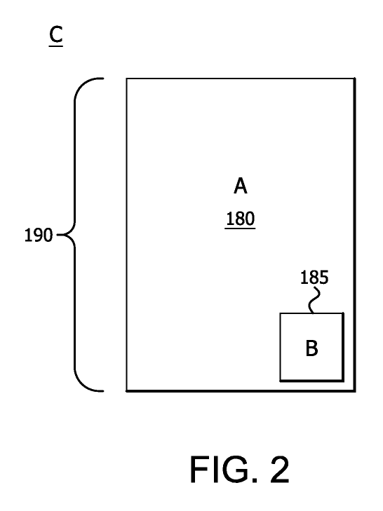

This content may have included therewith inband information according to an aspect of the present invention. The inband information may include additional information. This information may be related to the underlying content, or may be completely unrelated thereto. Referring now additionally to FIG. 2, there is illustrated exemplary content within content network 110 with associated inband information. As illustrated in FIG. 2, content 180, illustrated as television content, is combined with inband information 185 that when combined comprise enhanced content 190.

Inband information 185 may be embedded directly into content 180 upon creation and/or may be subsequently added into content 180 post production, for example. Inband information 185 may include interactive instructions to be followed by receiver network 130 during initiation of the interaction network 140 and/or may provide a subset of instructions for receiver network 130 to access subsequent or more detailed instructions.

Inband information 185 may include application instructions that are added during production or may include directions to acquire application instructions and/or additional application instructions, for example. Inband information 185 may take the form of a bar code, border image, or any other discernable feature. Such a discernable feature may be visual, auditory, or any other delivered feature that enables information to be passed within system 100. Although the present disclosure discusses inband information, the present invention may also include other types of information that may be included in the delivery of a signal. That is, inband information 185 is information included in the media stream that provides or initiates additional information or services related to the content 180. Inband information 185 provides instruction beyond identifying a point in the media stream. Inband information 185 may be able to be recognized, such as by being seen or heard, by a viewer, or may be specifically targeted to be hidden from a viewer and be received by a device, such as by being registered beyond the visual or audible spectrum, for example.

By way of non-limiting example, the present system may have content 180, such as a broadcast sitcom, with inband information 185 taking the form of an overlayed barcode. This barcode may encode information related to a trivia game about the associated sitcom that may be played online in trial form from the device that reads the barcode and possibly purchased in the future. This broadcast sitcom may be delivered to television(s) in a bar where viewers congregate to watch the show, for example. While watching, numerous users may initiate the software application by using their respective Smartphone to photograph an image of the sitcom displayed on the television along with the displayed barcode.

Each Smartphone may interpret the barcode and may activate the overlayed barcode information. At which point, the activated barcode may provide the Smartphone with certain information. This information may include sufficient information to fully execute the application on the Smartphone, either by providing the information to run the application or by providing information allowing Smartphone to access a dormant or other application or file, or download an application or file, or to remotely run an application. In each of these configurations external resources may be accessed. For example, the information may include instructions for the Smartphone to access a website using the wireless browsing of the Smartphone, and may provide login/PIN information to activate the software. Once navigated to the appropriate page, personal information may be conveyed and the trivia game trial may begin.

System 100 may provide enhanced content 190 created within and provided by content network 110 using a distribution network 120. Distribution network 120 may take the form of any of a plurality of distribution architectures. Distribution network 120 may operate within a framework for delivering content including, but not limited to, cable, radio, broadcast, and the like.

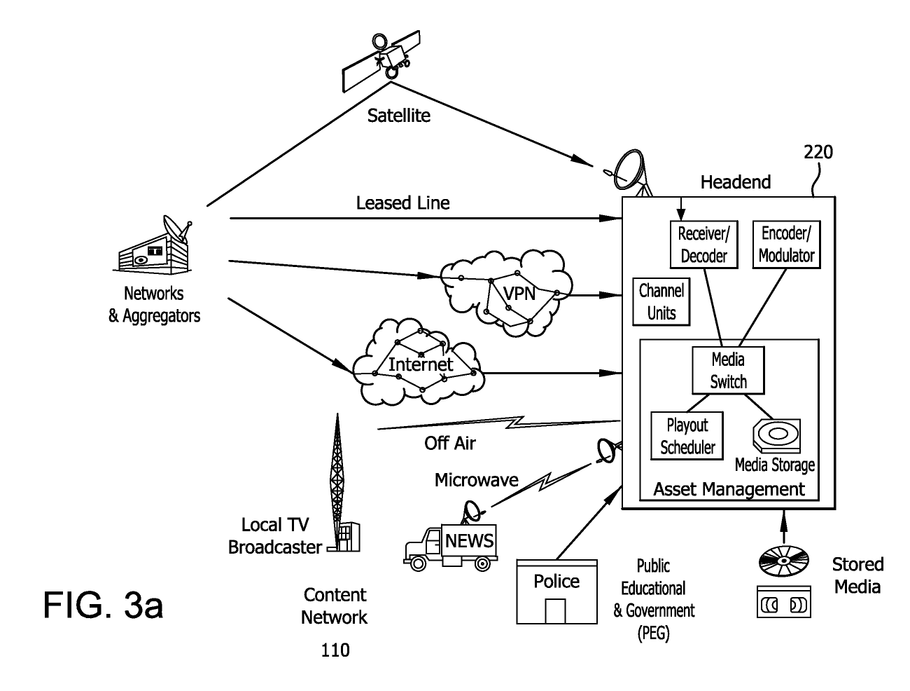

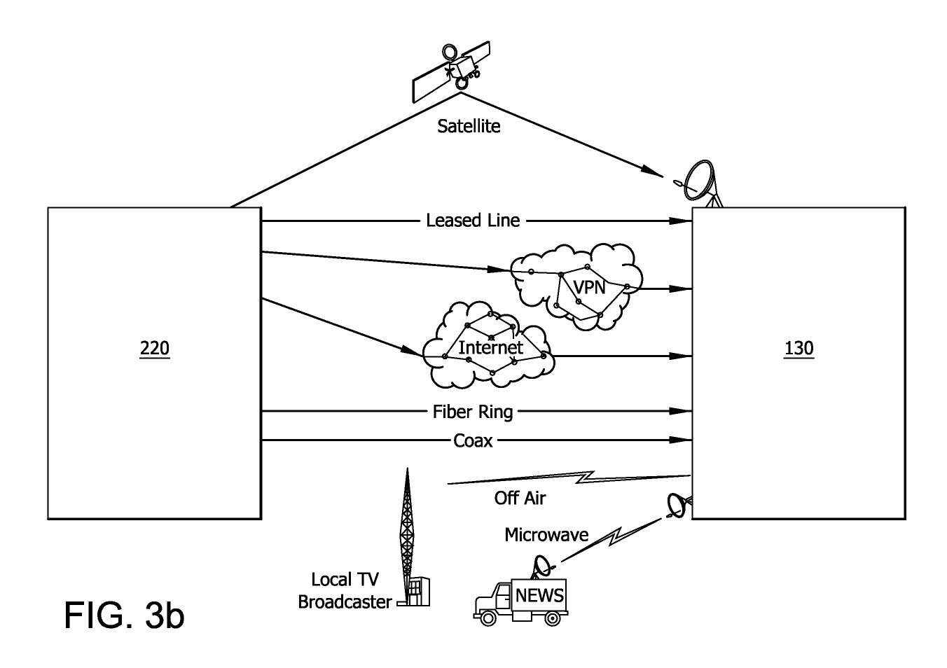

One example of a delivery system, provided for completeness of the present description without intending to limit the present disclosure to a specific type of delivery, is a cable television distribution network 120 illustrated in FIG. 3a. Distribution network 120 may take the form of a one-way (from the headend to the consumer) or two-way (from and to the headend and consumer) cable television system.

FIG. 3a illustrates distribution network 120 for distributing content from contribution sources to a content user as part of system 100. Distribution network 120 may include inputs from content network 110 and a headend 220, for example. Content network 110 feeds may be delivered to headend 220. This delivery may take the form of encoded transmissions, wireless broadcasts, wired connections, direct feeds, video tape, laser disc, and other delivery mechanisms. Headend 220 may receive the myriad of different incoming signals using a receiver and/or a decoder, and/or may locally, or internal thereto, maintain content storage. Headend 220 may perform asset management and may output a signal to distribution network 120. This output may be modulated and/or encoded.

Content network 110 may provide content to distribution network 120 from multiple sources via connections that range from dedicated high-speed fiber-optic connections to the delivery of stored content. Content sources may include program networks, content aggregators, and a variety of other government, education and public sources. CATV connection types may include satellite connections, leased lines, virtual networks, microwave, mobile data and public data networks, including the Internet.

In addition to gathering content via communication links, content network 110 and/or headend 220 may gather content from stored content. This may include remotely accessible or locally stored content. Examples of stored content include magnetic tapes, such as VHS or Beta, and optical disk, CDs or DVDs. When content is created in content network 110, the descriptive information of the content, such as metadata, may also be configured. The descriptive information may be embedded within the media file or files or may be sent as a separate data file or files. This metadata may include information about the inband information and/or the inband information may include information about the metadata. As illustrated in FIG. 3a, programming may be gathered through content network 110 from a variety of sources that may include satellite connections, leased lines, virtual networks, microwave links, mobile data, public data networks and the use of stored content. This content may be delivered to headend 220 for subsequent delivery within the television delivery system.

Distribution network 120 may include any network that operates to transmit, transfer, or otherwise cause signals to be received at receiver network 130 from content network 110. Headend 220 may be included solely within content network 110, primarily within distribution network 120, and/or may perform functions that are included within both content network 110 and distribution network 120. That is, headend 220 may be within content network 110, distribution network 120, or may be within both networks 110, 120. Referring now also to FIG. 3b, there is illustrated an exemplary distribution network for delivering content. As shown in FIG. 3b, content at headend 220 may be distributed to receiver network 130 using any means of communication. For example, satellite delivery, leased line delivery, virtual networks, microwave delivery, mobile data, public data networks, wireless connections, such as 3G and 4G, WIFI, WIMAX, a fiber ring, and even the more traditional fiber and coaxial cable connections, for example. Distribution network 120 may incorporate a fiber ring, for example, and may provide for delivery of signals output from headend 220 to receiver network 130.

Receiver network 130 may include an adapter box, such as a set-top box, and/or a cable ready television or a personal display device or Smartphone, for receiving, decrypting and/or decoding received signals for display. The received signals distributed through distribution network 120 may include content 180, inband information 185, and/or enhanced content 190. Inband information 185 may be added to content 180 to make enhanced content 190 up and until the content is delivered to a final destination, such as the receiving device of a user, for example. This addition may be performed by any device within the system that is relaying the media signal. As described above, these signals may be television signals, radio signals, Internet packets, or the like. As would be apparent to those possessing an ordinary skill in the art, the type of signal may have some determination in the type of receiver network 130 that may receive the distributed signals.

Based on the television show example above, the receiver network 130 may receive the television signal from distribution network 120. Receiver network, in this case, may adapt the received RF signals on the cable connection, for example, to a format that is accessible to a user. The receiver network may include a receiving device that is located in a user's home. Such a receiving device may interface with the cable network, select and decode cable channels, process the content into a form that the user can discern, and provide controls that allow the user to interact with the receiving network 130.

This receiving device may be specific to the viewer, such as a Smartphone, for example, or may be a software agent in a device linked more indirectly to a user, such as a set-top box or a television, for example. Receiver network 130 via the receiving device may access the inband information included with content 190 and act upon the information contained therein. This access may be responsive to a user interaction, such as a user using a Smartphone to photograph a television screen displaying the content and the overlayed inband information or pressing a button on a remote control to initiate the action. The access may also be automatic, such as the set-top box processing the inband information as the set-top box readies content 190 for display to a user.

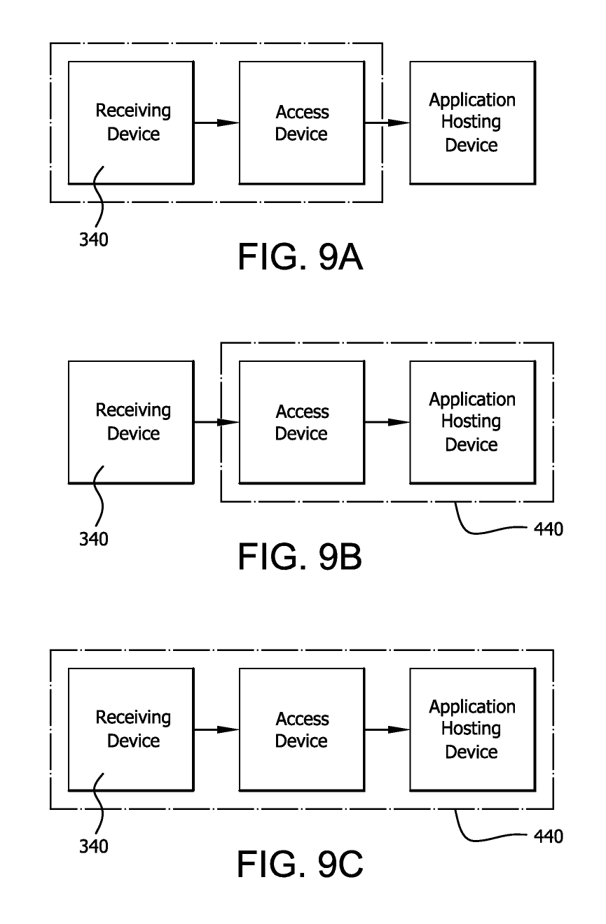

Referring now collectively to FIGS. 9a-c, further illustrating exemplary receiving device and application initiation architectures. FIGS. 9a-c describes the relationship among the receiving device 340, access device, and application hosting device. As may be seen in FIG. 9a, the receiving device and the access device may be the same device or housed within the same device. The device that hosts the application may be another device. FIG. 9a provides an illustration of the system 100 operating on an IPTV, wherein the IPTV displays content 180 while decoding inband information 185, either with or without user interaction, that may occur, if used, by a user interacting with a remote control, for example.

In FIG. 9b, the access device and the application hosting device may be the same device or housed within the same device. The device that displays content 190 may be another device. FIG. 9b provides an illustration of the system 100 operating in a configuration where a television in a bar displays content 190 and a viewer interacts with inband content 185 by using a Smartphone 440 to image the displayed content 190 thereon and activate an application on the Smartphone 440.

In FIG. 9c, the receiving device, access device, and application hosting device may be one device. FIG. 9c provides an illustration of the system 100 operating using a single device such as a Smartphone 440. The Smartphone 440 displays the content, either content 180 or content 190, and the inband information 185 is gathered, automatically or based on user interaction, to activate an application on or downloaded to the Smartphone 440.

Similarly, although not shown in the examples of FIG. 9, the receiving device, access device and application hosting device may have no overlap. That is, each of the receiving device, access device, and application hosting device may be different devices.

Further, receiver network 130 may have the ability to decode, or transcode information included within inband information. For example, if the inband information comprises a barcode, receiver network 130 may decode the bar code to extract the information contained therein. This information may provide instructions directly or indirectly to enable receiver network 130 to access or initiate interaction network 140.

Receiver network 130 may decode the inband information responsive to a viewer interaction based on a viewer identifying the inband information and seeking to run an application within interaction network 140. Receiver network 130 may automatically decode the inband information and access or initiate interaction network 140 based on the information contained in inband information.

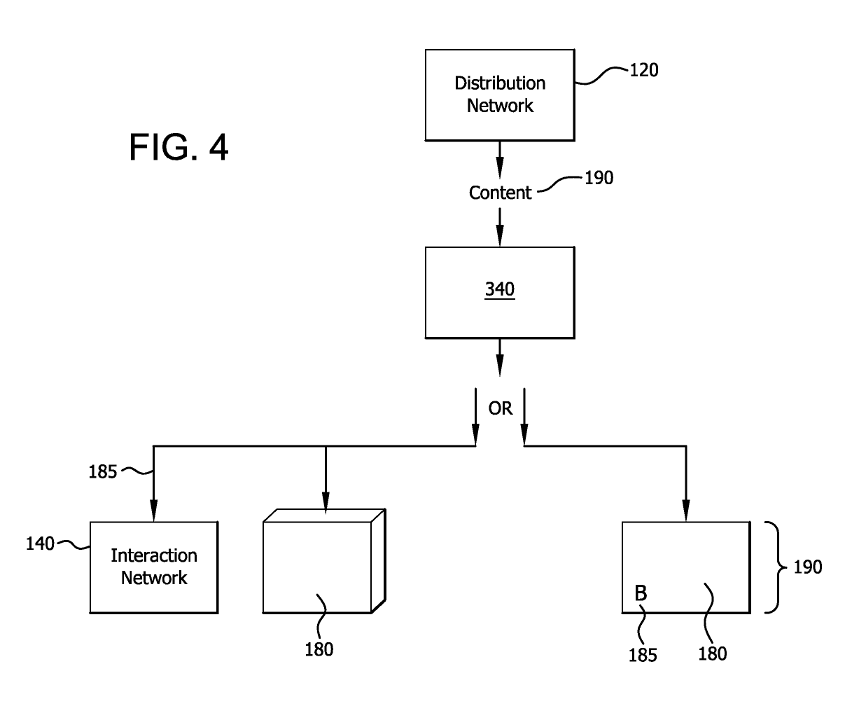

Referring additionally now to FIG. 4, there is illustrated a receiving device 340 within receiving network 130. Receiving device 340 may receive content 190 from distribution network 120. Upon receipt, receiving device 340 may display content 190, including content 180 and inband information 185, to a user(s). Receiving device 340 may require user interaction prior to processing inband information 185.

Alternatively, receiving device 340 may decouple enhanced content 190 into content 180 and inband information 185. This decoupling may result in content 180 being displayed on a display device, such as a television, and inband information 185 being decoded, thereby initiating interaction network 140.

Receiver network 130 may include information about the user, such as likes, dislikes, preferences, and other personal information. For example, this information may include geo-location of the receiving device and this information may be conveyed to user interaction network 140. This information may be included within receiving device 340, may be communicated to receiving device 340, and/or may be input by a user, or determined by user interaction within system 100. This information may be determined or accessed in real-time, such as when the information is stored locally on receiving device 340, for example. This information may be stored remotely within system 100, such as when the user inputs information prior to engaging system 100, in which case the information may be included within inband information, for example.

Interaction network 140 may launch a software application responsive to inband information 185. Interaction network 140 may have software to interpret inband information 185 to launch a software application. This launching software may be local to receiver network 130. The software application may be provided local to receiving device 340, such as by being resident thereon either active or dormant, and/or may be retrieved over a wireless or wired connection and run remotely or downloaded to receiving device 340. This software application may be based on content 180. Alternatively, the software application may be related topically, or may be completely unrelated in nature. The application may provide access to purchase items contained within content 180. The application may be a trivia game based on the facts of content 180. The application may be of interest to a user based on the included likes, dislikes and preferences and/or may be provided based on the geo-location of the user. For example, based on the time of day and location, the application may provide a link(s) to local nearby restaurants for dinner and enable a user to make a reservation for dinner, view menus, and the like. Alternatively, the application may provide a link(s) to local stores that carry items of clothing depicted in content 180, such as when content 180 is a television program, including close-by stores that have inventory of dresses worn by the leading actress in the television program, for example.

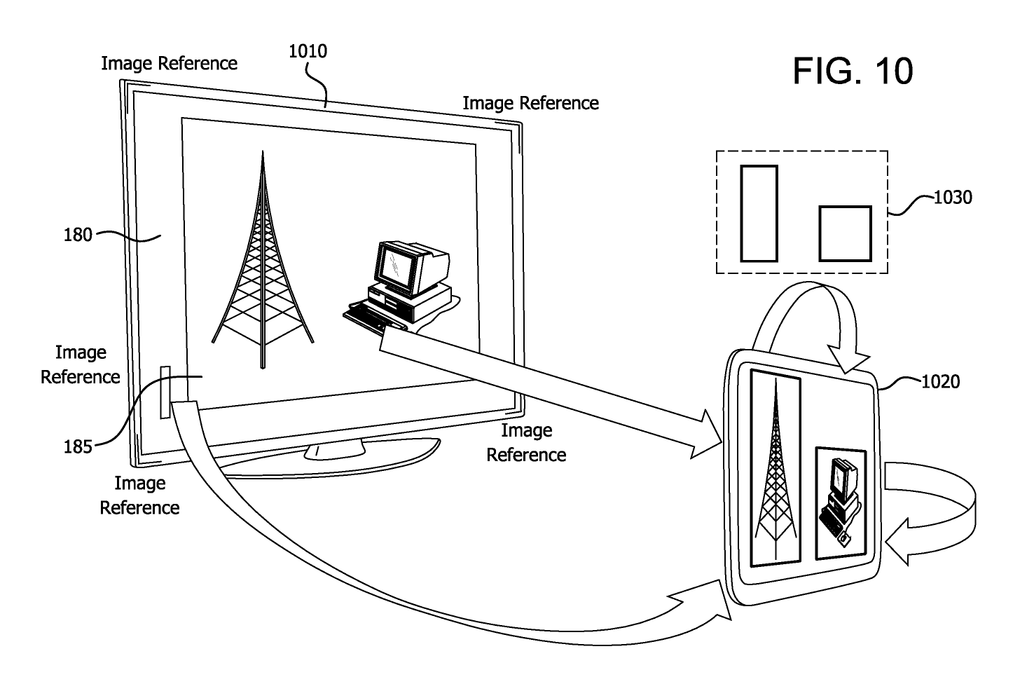

FIG. 10 illustrates a configuration of system 100 running an application that relates to and uses enhanced content 190. In this example, enhanced content 190 is displayed on display 1010 as delivered from a distribution network 120. In this example display 1010 is a television. Interpreting device 1020, operating as the access device and the application hosting device of FIG. 9b, interacts with display 1010 by imaging display 1010 with interpreting device 1020, such as by using the camera within interpreting device 1020. Interpreting device 1020 reads and interprets inband information 185. Based on inband information 185, device 1020 creates an overlay 1030 for interacting with the image of display 1010. Interpreting device 1020 may then display overlay 1030 overlayed on the image of display 1010. As shown the image of display 1010 contains inband information 185, although inband information 185 may be removed once interpreting device 1020 activates the application. This overlay may be achieved by calculating reference positions such as the corners of display 1010 and the position of inband information 185 and/or other notable features within the display. The image and/or overlay 1030 may be adjusted geometrically and positioned to allow a user to interact with the image. A user may now interact with the imaged screen by touching the screen of interpreting device 1020. This interaction may include identifying characters, actors, products, and the like. Updated images of display 1010 may be taken on interpreting device 1020 to update the interaction with a displayed scene.

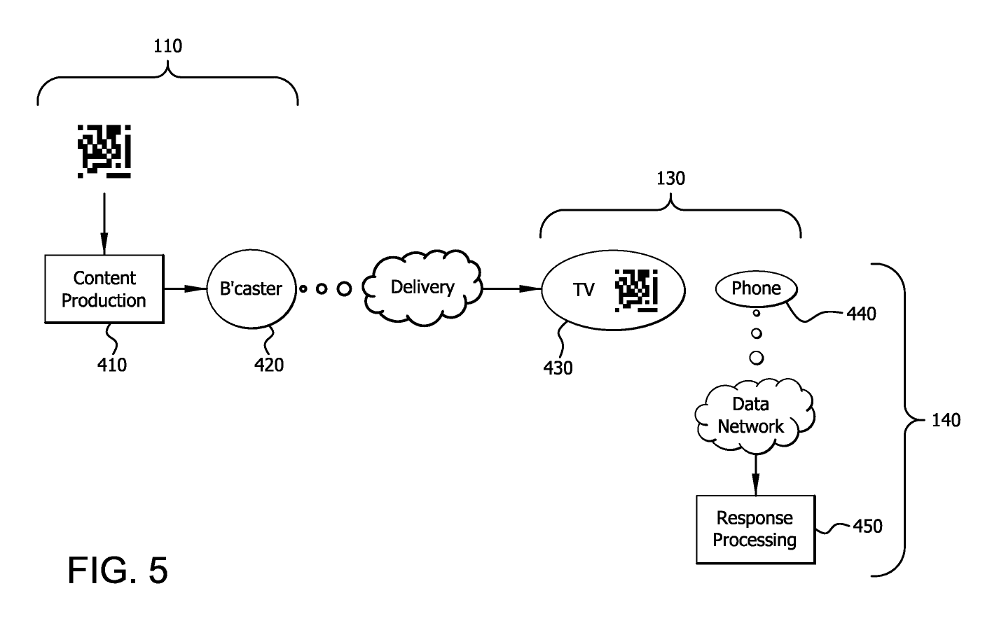

As discussed in brief above, inband information 185 may be incorporated within content 180 as content 180 is produced and/or may be added post production. A configuration for providing content with inband information included in the production stage is illustrated in FIG. 5. Specifically, FIG. 5 illustrates a delivery architecture based on to be delivered content including inband information that is embedded in content 180 during production of content 180. More specifically, FIG. 5 illustrates a content producer 410 within content network 110, a broadcaster 420 within distribution network 120, a display unit 430 and a phone 440 within receiver network 130, and phone 440 and a response processor 450 to prepare interaction network 140. Phone 440 may be included in both receiver network 130 and interaction network 140, as phone 440 may be used to receive and activate content 180, 185, 190. As depicted, phone 440 may activate interaction network 140 by interacting with content displayed on display unit 430. Phone 440 may process inband information 185 and launch interaction network 140.

As depicted in FIG. 5, broadcaster 420 (such as headend 220 and/or distribution network 120) may deliver content produced by content producer 410 to receiver network 130. Inband information may be present in the content, such as by being embedded with the content by content producer 410. Embedded inband information present in original content or programming may be ‘static.’ Inband information may be embedded in the content during production.

Receiver network 130 may present the embedded inband information to display unit 430 for display and subsequent viewing by a user(s). Display unit 430 may be a dumb display, such as a television, a smart display, such as an IPTV, or may be another type of broadcast receiver display, such as a cell phone, PDA, or radio, for example, capable of displaying or presenting content to a user.

This embedded inband information may be decoded and/or initiated by receiver network 130. In addition to inband information, receiver network 130 may acquire additional information, such as the location of viewing, such as by using GPS, for example, and/or identify the broadcast network, such as by using a response to a terms of delivery (ToD) query, for example, from sources other than content 190. Such additional informational may be stored by receiver network 130 and/or acquired in real-time based on information accessible through phone 440, for example.

Upon initiation, such as by phone 440 taking a photo of display unit 430, and subsequently processing inband information to thereby initiate receiver network 130 to activate response processor 450, such as over a data network, for example. Response processor 450 may be activated by a service or managed directly by the content producers, for example. Activation may include a request to download and run or initiate a software application, for example. Activation may include remotely running a software application from receiver network 130 across the internet, for example.

Response processor 450 may be controlled by entities that produced, and/or added inband information into the content from which the interaction network 140 was initiated. In the alternative, the underlying controlling entity may be unrelated to the content producing entity.

There are situations where inband information may be added to content after production. For example, the inband information may be added at any point prior to the delivery to the receiver. For instance, a cable operator may add the inband information. This adding of inband information may be governed by a set of rules, for example.

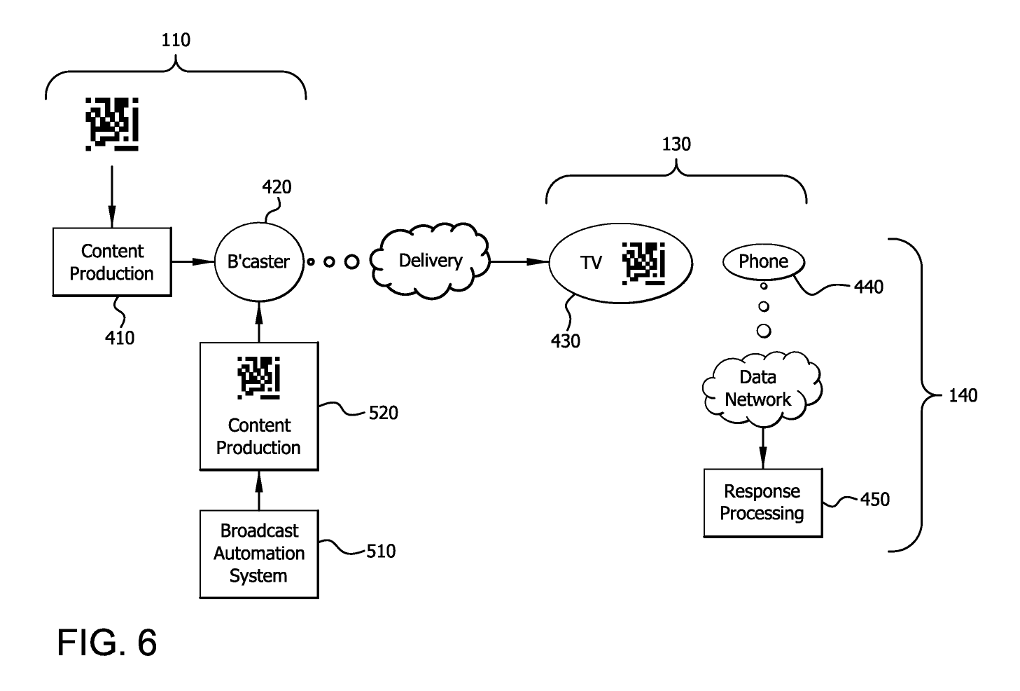

A configuration for providing content and incorporating inband information post production is illustrated in FIG. 6. FIG. 6 illustrates a delivery architecture based on to be delivered content combined with inband information post-production. Again for example, the inband information may be added, augmented replaced, or modified at any point prior to the delivery to the receiver. For instance, a cable operator may add the inband information. This adding of inband information may be governed by a set of rules, for example. Also, by way of non-limiting example, content provider may include reference to inband information, broadcaster may use that information to create a new version of the inband information, replacing the original inband information, such as by overlaying the new inband information over the original inband information. Delivery agents including the cable provider, for example, may further modify the inband information to include reference to the cable system. The household devices, such as a settop box, may interpret and modify the inband information before the display of inband information, for example, such as to include the account number of the household. More specifically, FIG. 6 illustrates content producer 410, broadcaster 420, display unit 430, receiving device 340, and response processor 450, and a broadcast automation system 510, and a code producer 520. Content producer 410, broadcast automation system 510, and code producer 520 may make up content network 110. Broadcaster 420 may make up distribution network 120. Display unit 430 and phone 440 may be within receiver network 130, and phone 440 and a response processor 450 may prepare interaction network 140. As was described with respect to FIG. 5, phone 440 may be included in both receiver network 130 and interaction network 140, as phone 440 may be used to receive and activate content 180, 185, 190. As depicted, phone 440 may activate interaction network 140 by interacting with content displayed on display unit 430. Phone 440 may process inband information 185 and launch interaction network 140.

As illustrated in FIG. 6, content production 410 may produce content 180 in the content network 110 for broadcast. In this example, content producer 410 does not include inband information within content 180; and therefore inband information may be subsequently added. Specifically, broadcast automation system 510 may receive content 180 from content producer 410 and may have inband information generated by code producer 520. Broadcast automation system 510 may overlay the generated inband information 185 to produce enhanced content 190. This overlay may occur prior to broadcasting or during broadcast. Code producer 520 may generate inband information, such as by using a code generator and/or an audio video mixer, for example. Inband information 185 may be overlayed on content 180 to thereby be considered static. Broadcast and network information may be included in inband information. Therefore, inband information may be changed or added based on network/ToD with original content 180 remaining static.

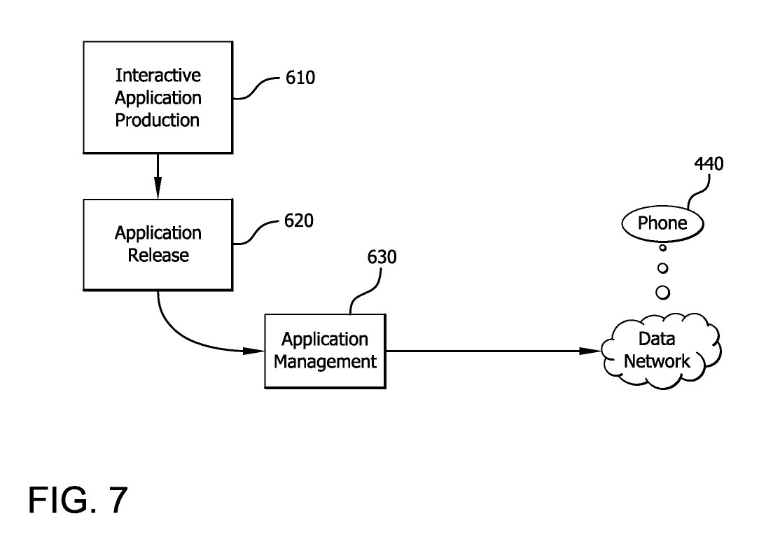

An example of interaction network 140 is shown in FIG. 7. FIG. 7 illustrates an interactive application production 610, application release 620, and application management 630, accessible via a data network interconnected with receiving device 340. Receiving device 340, such as a phone, for example, may host an application that processes the inband information and executes one of multiple application choices as indicated by the parameters in the embedded inband information. This hosted application by receiving device 340 may enable the initial processing of inband information 185 in content 190 and may be monolithic or may merely be a processor that identifies from inband information 185 another application to be downloaded or executed. Alternatively, this other application may be preloaded/predownloaded on receiving device 340 to be executed by the hosted application or processor without additional downloading. Interactive application production 610 may produce interactive applications that are developed in parameterized format and incorporated into a monolithic application, for example. The interactive application may be released, and updated, to existing download sites. Upon a request by receiving device 340, as instructed by inband information, for the application, the application may be downloaded and installed on receiving device 340.

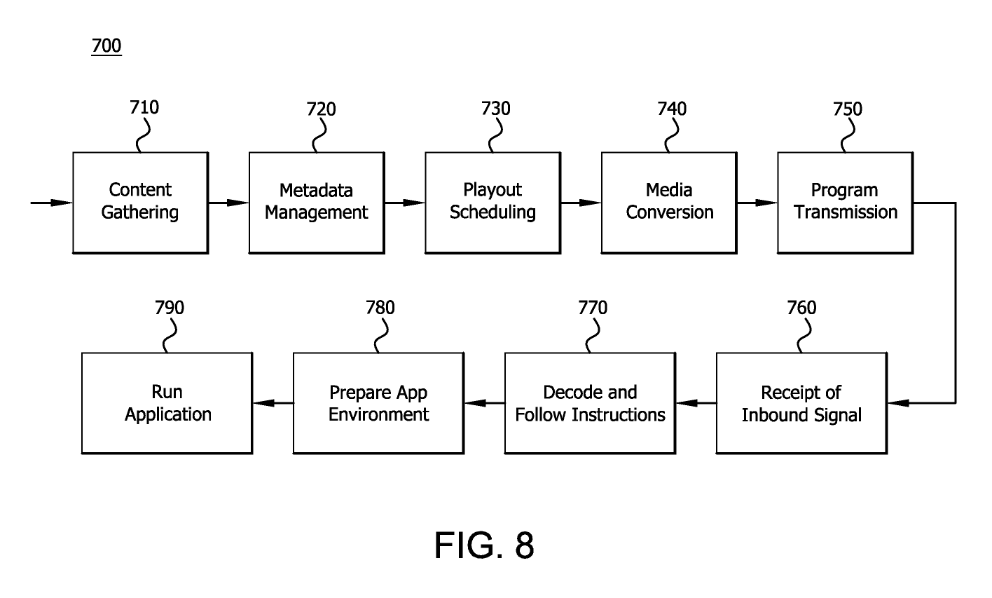

A method 700 for delivering content is illustrated in FIG. 8. Method 700 may include gathering content 710, managing metadata 720, scheduling 730, converting content 740, and transmitting content 750. Gathering content 710 may include the gathering of content from network aggregators and other sources. After the content is acquired, the content may be adapted and stored. Adapting and storing the content is a process for which content is acquired, such as from satellite downlink or data connection, for example, and loaded onto initial video servers. This content may be stored with the embedded inband information. Once content is adapted and stored, this content may be edited and added to, such as by adding inband information and/or commercials, and may be migrated to server(s) or played directly for delivery. Gathering content 710 may involve applying a complex set of content licensing requirements, restrictions and associated costs to the content. These requirements, restrictions and costs may require limiting the distribution to certain geographic areas and/or broadcast territories, the types of viewers that are able to receive the content and specific use limitations. Content that is gathered may include or have inband information added thereto.

Managing data 720 may include the process of identifying, describing, and applying rules to descriptive portions of content assets. Metadata normalization may be needed and may adjust the metadata elements into standard terms and formats to allow for more reliable organization, selection, and presentation of program descriptive elements. Metadata may be used to create or supplement the electronic programming guide, for example. Metadata may be related to inband information and that information may be shared. That is, inband information may include some or all of the metadata information. Further, metadata information may include information regarding the inband information.

Scheduling 730 may include the process of setting up the event times to transfer content or programs to viewers or distributees of the content. Scheduling 730 may include equipment or applications that may initiate, manage, and terminate, transferring or streaming of the content to users or distributors of the content on a predetermined time schedule or when specific criteria have been met. Scheduling 730 may be used to select and assign programs to time slots on linear television channels. Scheduling 730 may be linked to the broadcast automation system 510 to ensure that inband information is included with the content prior to delivery.

Converting content 740 may include content processing. Such content processing may include a caption, modification, or merging of content into other formats. Content processing may also include graphics processing, encoding, and or transitory processing. Inband information may be designed to remain with the content during and through conversion 740. Alternatively, inband information may be overlayed on the content after conversion 740, either by generation by code producer 520 or by removal from the content pre-conversion and overlaying on content post-conversion. A graphic processor may be used. A graphics processor is an information processing device that may be dedicated for the acquisition, analysis, and manipulation of graphics images. Graphics processing may be required to integrate, such as merging or overlaying, graphic images with the underlying programs. Content encoding may manipulate information or data into another form. Content encoding may include content compression, such as reducing bandwidth, transmission coding, such as adapting the transmission channel, and channel coding, such as adding control commands for specific channels. Transcoding may be the conversion of digital signals from one coding format to another, such as converting from MPEG-2 compressed signals into MPEG-4 AVC coded signals, for example. Converting content 740 may also include ad insertion.

Once the content is delivered, method 700 may also include receipt of the inband information 760 and decoding and implementing the instructions 770. Receipt of the inband information 760 may include a user interacting with the inband information, or may operate in a more automatic fashion, such as the receiver receiving the information during initial signal processing.

Once the inband information is received, the signal may be decoded and the information contained within the inband information implemented 770. This may include launching an application based on specific instructions encoded within the inband information. A web browser may be opened and directed to a specific site or address, for example.

Method 700 may include preparing the application environment 780 and running the application 790. Preparing the application environment 780 may comprise downloading of the application to a local processor. Preparing 780 may also include unzipping or decompressing information and installing software to run. Once prepared, the application may be run 790.

As will be apparent to those skilled in the art, the networks and systems within the present invention may draw on any number of communication access points and content sources, including wired and wireless, radio and cable, telephone, television and internet, personal electronic devices, satellite, databases, data files, and the like, in order to increase content, contribute content, and best allow for recommendations and delivery.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention as set forth in the claims hereinafter.

What is claimed is:

1. A system for selectively delivering content to a user, said system comprising:
information included along with the content, wherein said information comprises at least one instruction to enable access to an interactive application;
an interactive application that is accessed by interacting with said information, said interactive application enabling further interaction with the system.

2. The system of claim 1, wherein said at least one instruction provides access to more detailed instructions for accessing said interactive application.

3. The system of claim 1, wherein accessing said interactive application includes at least one of downloading and installing said interactive application on a device performing said interacting.

4. The system of claim 1, wherein accessing said interactive application includes at least activating said interactive application that has been preloaded.

5. The system of claim 1, wherein said information is included within a barcode.

6. The system of claim 1, wherein said information is embedded within the content.

7. The system of claim 6, wherein said information is embedded within the content during production of the content.

8. The system of claim 6, wherein said information is embedded within the content after the production of the content.

9. The system of claim 8, wherein said information is embedded within the content using a code producer.

10. The system of claim 8, wherein said information is embedded within the content using a broadcast automation system.

11. The system of claim 8, wherein said information is embedded using a post-production overlay.

12. The system of claim 1, wherein the content is broadcast to a user.

13. The system of claim 1, wherein the content is television programming.

14. A method for selectively providing interactive content, said method comprising:
delivering content including inband information;
processing at least the inband information;
launching an application based on the processed inband information,
wherein said launched application provides interactive content.

15. The method of claim 14, wherein said inband information is overlayed on the content.

16. The method of claim 14, wherein said delivering content comprises content gathering.

17. The method of claim 14, wherein said delivering content comprises metadata management.

18. The method of claim 14, wherein said delivering content comprises playout scheduling.

19. The method of claim 14, wherein said delivering content comprises content conversion.

20. The method of claim 14, wherein said delivering content comprises program transmission.

21. The method of claim 14, wherein said processing includes decoding the inband information.

22. The method of claim 21, further comprising following the instructions produced by decoding the inband information.

23. The method of claim 14, wherein said launching includes preparing an application environment.

24. The method of claim 14, wherein said launching includes running an application.

25. The method of claim 24, wherein said application is downloaded.

26. The method of claim 24, wherein said application is preloaded.

27. The method of claim 14, wherein the application is a software application.

28. The method of claim 14, wherein the application is an interactive application.

29. The method of claim 14, wherein said inband information is included within a barcode.

30. The method of claim 14, wherein said inband information is embedded within said delivered content.

31. The method of claim 30, wherein said inband information is embedded within said delivered content during production of the content.

32. The method of claim 30, wherein said inband information is embedded within the content after the production of the content.

33. The method of claim 30, wherein said information is embedded within the content using a code producer.

34. The method of claim 30, wherein said information is embedded within the content using a broadcast automation system.

35. The method of claim 30, wherein said inband information is embedded within the content using post-production overlay.

36. The method of claim 12, wherein said delivered content is broadcast.

37. The method of claim 12, wherein said delivered content is television programming.
